(19) United States
(12) Patent Application Publication
(10) Pub. No.: US 2009/0120084 A1
(43) Pub. Date: May 14, 2009

(54) Hydraulic Unit

(76) Inventor: Herbert Baltes, Losheim (DE)

Correspondence Address: Roylance Abrams Berdo & Goodman, 1300 19th Street NW Suite 600, Washington, DC, 20036, US

(21) Appl. No.: 11/992,053

(22) PCT Filed: Aug. 5, 2006
(86) PCT No.: PCT/EP2006/007768

§ 371 Date: Mar. 14, 2008

(30) Foreign Application Priority Data
Nov. 2, 2005 (DE) 10 2005 052 108.8

(51) Int. Cl. F16D 31/02

(52) U.S. Cl. 60/414

(57) ABSTRACT

Hydraulic unit, in particular for lifting and lowering loads in stacking trucks having at least one working cylinder (10), the piston/rod unit (12) of which is guided movably in a housing (22) and, by means of a hydraulic pump (25), can be extended in its one drive direction (30) and can be retracted in its other opposite drive direction (32), and having a control device (20) for actuating the displacement movements to that effect. It is distinguished by the fact that there is a storage device (38) which is fed energy in one drive direction (32), and by the fact that the energy which is fed in can be called up from the storage device (38) in order to assist a displacement movement in an opposite drive direction (30).

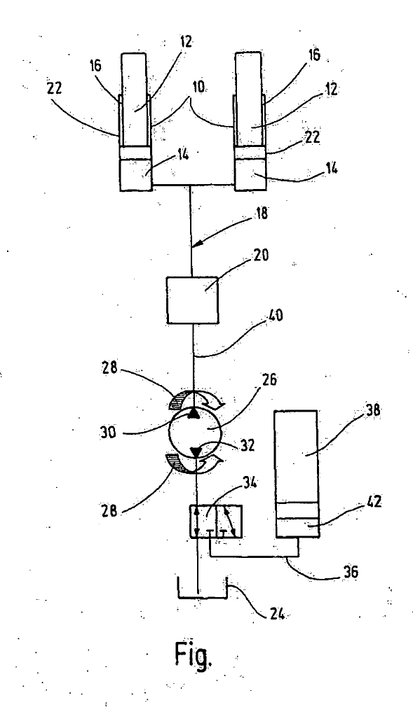

The invention relates to a hydraulic unit, especially for raising and lowering loads in stacking trucks, with at least one working cylinder which has a piston-rod unit which is movably guided in a housing and which can be extended by means of a hydraulic pump in its one drive direction and can be retracted in its other, opposite drive direction, and with a control means for actuating these displacement movements.

DE 10 2004 044 244, which was published at a later date, discloses as the hydraulic unit a spring system, in particular for use in the lifting frame of a forklift, with at least one hydraulic accumulator and at least one switching valve for producing a fluid-carrying connection by means of a control line between the hydraulic accumulator and a working cylinder which can actuate the lifting frame, and with a lifting and lowering line for actuating the working cylinder into a raised or lowered position, the lifting and the lowering line each discharging into a main branch, which running parallel to one another, with one connecting point upstream and downstream from the switching valve, discharge into the control line, and valves being connected to the main branches, which valves have an opposite action direction or actuation direction for each main branch. With this design a type of hydraulic Graetz circuit is implemented, and with the indicated solution it is possible with only a few installation components and especially also only using one hydraulic accumulator to achieve active load damping or cushioning in the lifting frame of the forklift. More energy-efficient operation is, however, not possible with the known solution.

The prior art furthermore discloses generic hydraulic units in which two working cylinders which are connected to one another on the piston side in the form of so-called plunger cylinders are connected to a conventional hydraulic pump. The hydraulic pump made as a constant delivery pump can have two opposite directions of rotation and accordingly two opposite transport directions for the fluid medium used. A control means which can be actuated on the operator side as a control block allows actuation of the hydraulic pump, a conventional electric motor being used for driving it. To extend the working cylinders and thus to lift a load, in the known solution the hydraulic pump takes fluid from a tank storage vessel and pushes the removed fluid to the piston side of the indicated working cylinder unit. To lower the load and thus to retract the working cylinders, the direction of rotation of the hydraulic pump is reversed, and the fluid which has been displaced via the piston side travels in turn to the tank side of the known hydraulic unit. To raise and lower loads, the known unit requires high hydraulic pump work capacity and therefore a high driving power for the upstream electric motor. The known hydraulic unit is also limited with respect to the possible displacement speed for the working cylinders.

Proceeding from this prior art, the object of the invention is to further improve the known solutions such that energy-efficient operation of the pertinent hydraulic unit is possible at low cost. This object is achieved by a hydraulic unit with the features of claim 1 in its entirety.

In that, as specified in the characterizing part of claim 1, there is a storage device which feeds energy in one direction of driving of the hydraulic pump, and in that the supplied energy can be retrieved from the storage device to support displacement movement for the opposite driving direction of the hydraulic pump, in particular the movement of load lifting can be carried out with energy support from the storage device; this results in lower driving power for the hydraulic pump with its motor. The retrieved energy at a high pressure level of the fluid from the storage device can also be used for faster displacement movements on the respective working cylinder; this benefits a high-speed operating process. Furthermore, it has been found that by using the storage device, overall harmonical operation of the entire hydraulic unit without jolts can be achieved. By simply reversing the direction of rotation of the hydraulic pump, the amount of fluid displaced from the working cylinder when the load is lowered can be pushed into the storage device to increase the pressure level and can be retrieved again from there in the next working cycle.

It has been found to be especially advantageous to use a hydraulic accumulator particularly as a piston accumulator for the storage device and, as part of the control means which is guided on the operator side, a valve unit is used to establish or interrupt a fluid-carrying connection between the hydraulic pump and the storage device.

In spite of the expected additional costs for an additional storage device, preferably in the form of a hydraulic accumulator, the expected savings due to energy-efficient operation can be assumed to be higher, so that even for a short interval of use of energy storage these additional costs are equalized. Operating costs overall can therefore be reduced in these hydraulic units by using the storage device.

The hydraulic unit according to the invention will be detailed below using one embodiment as shown in the drawings. In this connection the single FIGURE schematically shows a block diagram of the hydraulic unit according to the invention, not to scale.

The hydraulic unit is used, in particular, to raise and lower loads, which are not detailed, in stacking trucks such as forklifts or other industrial trucks. The unit has two working cylinders 10 of conventional design which are also referred to as plunger cylinders in the jargon. Each working cylinder 10 has a piston-rod unit 12 which divides the respective working cylinder 10 essentially fluid-tight into a piston side 14 and a rod side 16. As the FIGURE furthermore shows, the two piston sides 14 of the working cylinders 10 are connected to one another to carry fluid via a connecting line designated as a whole as 18 and in this way are connected to the operator-guided control means 20 in the manner of a control block. The rod sides 16 are supplied with fluid as necessary, conventionally in a manner no longer detailed, and this amount of fluid can also be suitably transported again out of the rod side 16 as an annulus.

The respective piston-rod unit 12 is guided in the housing 22 of the working cylinder 10 and for a process of lifting a load which is not detailed and/or for extending the lifting frame of a forklift, viewed in the line of sight, the piston rod unit 12 is extended upward from the housing 22, and for a lowering process the piston-rod unit 12 moves in the direction to the piston side 14 of each working cylinder 10. These lifting and lowering processes are known so that they will no longer be detailed here.

Furthermore, between the control means 20 and a supply or storage tank 24, a conventional hydraulic pump 26 with two opposite directions of rotation which are indicated in the FIGURE with arrows 28 is connected to the connecting line 18. With respect to the opposite directions of rotation 28, the hydraulic pump 26 can transport fluid in two opposite-directions 30, 32 which are reproduced as shown in the FIGURE by the standard arrows of the standardized drawing of the hydraulic pump 26. The hydraulic pump 26 can be made as a constant delivery pump.

Between the hydraulic pump 26 and the tank 24 a valve unit 34 is connected as a 3/2-way or switching valve which is reproduced as shown in the FIGURE in one actuating position for which there is a fluid-carrying connection between the hydraulic pump 26 and the tank 24. A branch line 36 to the storage device 38 in the form of a hydraulic accumulator as a piston accumulator is blocked in this switching position. In the other inhibition of switching of the directional valve, conversely in this way a fluid-carrying connection between the branch line 36 and entry side of the hydraulic pump 26 is established. In that case the tank connection to the tank 24 is blocked.

The operator-guided control means 20 is able to analogously actuate both the hydraulic pump 26 and also the valve unit 34. A conventional electric motor which is not detailed and which can be actuated by the control means 20 is used to operate the hydraulic pump 26. Furthermore, for monitoring of system states, a measurement point 40 is connected between the control means 20 and the hydraulic pump 26 in order to monitor the pressure of the system in this way, for example. Depending on the sensors used, more extensive monitoring activities can also be carried out, even in combination with one another, relative to the temperature, viscosity, degree of fouling, etc., of the respective fluid used.

When the hydraulic unit is initially started up, when the accumulator 38 is not filled on the fluid side, the valve unit 34 is in the switching position shown in the FIGURE, and the hydraulic pump 26 takes fluid from the tank 24 and pushes the amount referred to in the direction of the piston side 14 of the working cylinders 10 for a lifting process. If at this point the load is lowered, the valve 34 is actuated and the amount of fluid which has been returned via the hydraulic pump 26 at this point travels to the fluid side 42 of the storage device 38 and accordingly lifts the piston against the working gas storage. It is recognized that for a hydraulic accumulator the separating element such as a piston or a membrane separates the fluid side from the gas side which is enclosed in the accumulator housing and which in this way can store energy compressed. If at this point a repeated load lifting process is actuated, the energy stored in the storage device 38 in the form of a high pressure level is retrieved and supports the lifting movement by the amount of fluid which has been retrieved from the accumulator being pushed toward the piston side 14 of the respective working cylinder 10. In this way, a type of energy storage can be achieved which can support the load lifting process when called upon.

The hydraulic unit according to the invention is characterized by use of the storage device 38 in that short system and reaction times are possible at high extension and retraction speeds for the working cylinders 10 used, and the electric drive of the hydraulic pump 26 is relieved accordingly. Furthermore, it has been found that all working movements damped by energy input into the storage device 38 take place harmonically and thus without jolting. In spite of the additional costs for implementation of the indicated storage device, especially in long-term operation the accompanying energy savings is more cost-efficient than in systems without a storage device. The transport or capacity performance of the hydraulic pump 26 can also be cut back by using the energy storage device 38; this in turn helps reduce production costs.

The hydraulic pump used, as shown, can have two directions of rotation; the two directions of rotation, however, can also be implemented by means of the electric motor. It is also possible to analogously replace the indicated constant delivery pump by a variable delivery pump and the electric motor can also be replaced by another drive device, for example by an internal combustion engine, preferably in the form of a diesel engine, a machine or the like. The hydraulic unit according to the invention is not limited to use in stacking trucks, but can preferably be used wherever potential energy can be applied with the respective working cylinder. Analogous use is accordingly possible in machines such as excavators, but also in the field of elevators and handling devices (manipulators).

The directional valve which is used in the circuit as shown in the FIGURE is made as a 3/2-way valve; here implementation with a 3/3-way valve which can contribute according to the switching position to relieving the control means 38 is also conceivable. Furthermore the control means 20 shown in the FIGURE need not be implemented in this way and accordingly can be omitted. Basically only one control means is necessary for actuating the motor and/or the indicated hydraulic pump. Instead of the control means 20 shown in the FIGURE, a pipe shearing pin or the like can be inserted into the hydraulic unit (not shown). Corresponding sensors with measurement points for the hydraulic accumulator can also be inserted into the actuation of the overall system. Thus, other conclusions for actuating the overall hydraulic unit can also drawn, for example, by monitoring the piston position of the hydraulic accumulator and via the degree of its fill volume and/or fill pressure.

1. A hydraulic unit, in particular for raising and lowering of loads in stacking trucks, with at least one working cylinder (10) which has a piston-rod unit (12) which is movably guided in a housing (22) and which can be extended by means of a hydraulic pump (26) in its one drive direction (30) and can be retracted in its other, opposite drive direction (32) and with a control means (20) for actuating these displacement movements, characterized in that there is a storage device (38) which feeds energy in one direction of driving (32), and that the supplied energy can be retrieved from the storage device (38) to support displacement movement for the opposite driving direction (30).

2. The hydraulic unit according to claim 1, wherein, when the piston-rod unit (12) is lowered, energy is supplied and, when raised, the supplied energy is used for support.

3. The hydraulic unit according to claim 1, wherein the storage device (38) is formed from at least one hydraulic accumulator, in particular a piston accumulator, which can be connected or disconnected by means of a valve unit (34) which can be actuated via the control means (20).

4. The hydraulic unit according to claim 3, wherein the valve unit (34) is a directional valve which in one switching position clears the fluid-carrying path between the tank connection T and the hydraulic pump (26), and in the other switching position establishes a fluid-carrying connection between the hydraulic pump (26) and the storage device (38).

5. The hydraulic unit according to claim 1, wherein the control means (20) is connected to a fluid-carrying connection between the respective working cylinder (10) and the output side of the hydraulic pump (26).

6. The hydraulic unit according to claim 5, wherein a measurement point (40), in particular a pressure measurement point, is connected to the connecting line (18) between the control means (20) and the output side of the hydraulic pump (26).

7. The hydraulic unit according to claim 1, wherein a double working cylinder arrangement (10) is used which is connected to the output side of the control means (20) to carry fluid on the piston side (14).
